(19) United States
(12) Patent Application Publication
(10) Pub. No.: US 2017/0048684 A1
(43) Pub. Date: Feb. 16, 2017

(54) METHODS, DEVICES, AND NODES FOR OPTIMIZED SHORT MESSAGE SERVICE RELAY FOR CELLULAR INTERNET-OF-THINGS

(71) Applicant: TELEFONAKTIEBOLAGET L M ERICSSON (PUBL), Stockholm (SE)

(72) Inventors: Hans Bertil RÖNNEKE, Kungsbacka (SE); Peter HEDMAN, Helsingborg (SE)

(73) Assignee: TELEFONAKTIEBOLAGET L M ERICSSON (PUBL), Stockholm (SE)

(21) Appl. No.: 14/826,824

(22) Filed: Aug. 14, 2015

(51) Int. Cl. H04W 4/14; H04L 29/08; H04W 24/02; H04L 5/00

(52) U.S. Cl. CPC H04W 4/14; H04L 5/0055; H04L 69/329; H04L 69/326; H04W 24/02; H04W 88/16

(57) ABSTRACT

A method performed in a wireless communication device includes the wireless communication device implementing a Short Message Service (SMS) protocol stack that includes a layer for relaying SMS messages that is configured to provide a communication interface between the wireless communication device and a control node. The method further includes the layer for relaying SMS messages using a sub-layer configured to deliver small data between the wireless communication device and the control node.

### TECHNICAL FIELD

This disclosure relates generally to relay of Short Message Service (SMS) messages, more particularly, to methods, devices, and nodes for optimized SMS relay for Cellular Internet-of-Things (CIoT).

### BACKGROUND

Many CIoT devices are expected to be ultra-low cost, low complexity and low bitrate devices. For such types of devices, it is essential that the software “footprint” (e.g., protocol stacks in the device), are kept as small as possible in terms of memory size and with as low complexity as possible to reduce cost and processing requirements. It is also essential that information communicated has a minimized overhead since every bit sent over a radio interface is costly in terms of power for the device and in terms of radio resources for the network operator.

The current SMS standard uses protocols that are quite “talkative” over the radio (e.g. the RP/CP protocols) and have an excessive number of layers in the protocol stack. FIGS. 1 and 2 illustrate the conventional SMS protocol between a mobile station (MS) 102 and mobility management entity (MME) 104. These protocols are specified in 3GPP TS 24.011 v12.0.0, the entire contents of which are incorporated herein by reference. The conventional SMS protocol stack 100 includes the Short Message Application Layer (SM-AL), the Short Message Transport Layer (SM-TL), the Short Message Relay Layer (SM-RL), and sublayers connection management sublayer (CM-sublayer) and EPS mobility management sublayer (EMM-sublayer). More specifically, the SM-RL in the MS 102 uses sub-layers 102a and 102b, and the SM-RL in MME 104 uses sub-layers 104a and 104b.

The CM sublayer, in terms of the SMS Support, provides services to the SM-RL. On the MS side, the SM-RL provides services to the SM-TL. The SM-RL is the upper layer on the network side (MSC or SGSN or MME), and the SM user information elements are mapped to TCAP/MAP. The peer protocol between two SMC entities is denoted SM CP, and between two SMR entities, SM RP.

In FIG. 2, it is shown that four messages over the radio between the EMM entity in the MME and the EMM entity in the UE are required to convey one mobile terminated short message service (MT SMS). As illustrated in FIGS. 1 and 2, the current SMS standard uses protocols that are quite “talkative” over the radio (e.g. the RP/CP protocols) and with quite excessive number of layers in the protocol stack. For example, in FIG. 2, it is shown that 4 messages are needed to convey one SMS from the network to the UE.

For a CIoT device that is ultra-low cost, low complexity and that uses low bitrate radio channels, it is a large effort and inefficient to convey SMS's in terms of the time it takes to communicate the necessary data bits which directly affect the power consumption in the constrained CIoT device. It is further a large effort and inefficient in terms of the amount of software size (i.e. “footprint”) for the SMS protocol stack required in the device. It is also a large effort and inefficient in terms of complexity which affects the cost and processing requirements of the CIoT device, as well as the amount of radio resources utilized, which affects the network operator.

### SUMMARY

According to some embodiments, a method performed in a wireless communication device includes the wireless communication device implementing a Short Message Service (SMS) protocol stack that includes a layer for relaying SMS messages that is configured to provide a communication interface between the wireless communication device and a control node. The method further includes the layer for relaying SMS messages using a sub-layer configured to deliver small data between the wireless communication device and the control node.

According to some embodiments, a method performed in a control node includes the control node implementing a Short Message Service (SMS) protocol stack that includes a layer for relaying SMS messages that is configured to provide a communication interface between the control node and a wireless communication device. The method further includes the layer for relaying SMS messages using a sub-layer which is configured to deliver small data between the control node and the wireless communication device.

According to some embodiments, a wireless communication device (WCD) includes a processor and a computer readable medium coupled to the processor, said computer readable medium containing instructions executable by the processor. The WCD is operative to implement a Short Message Service (SMS) protocol stack that includes a layer for relaying SMS messages that is configured to provide a communication interface between the wireless communication device and a control node. The WCD is operative to the layer for relaying SMS messages using a sub-layer configured to deliver small data between the wireless communication device and the control node.

According to some embodiments, a control node includes a processor and a computer readable medium coupled to the processor, said computer readable medium containing instructions executable by the processor. The control node is operative to implement a Short Message Service (SMS) protocol stack that includes a layer for relaying SMS messages that is configured to provide a communication interface between the control node and a wireless communication device. The layer for relaying SMS messages uses a sub-layer which is configured to deliver small data between the control node and the wireless communication device.

### BRIEF DESCRIPTION OF THE DRAWINGS

The accompanying drawings, which are incorporated herein and form part of the specification, illustrate various embodiments of the present disclosure and, together with the description, further serve to explain the principles of the disclosure and to enable a person skilled in the pertinent art to make and use the embodiments disclosed herein. In the drawings, like reference numbers indicate identical or functionally similar elements.

FIG. 1 is an illustration of a SMS protocol stack.

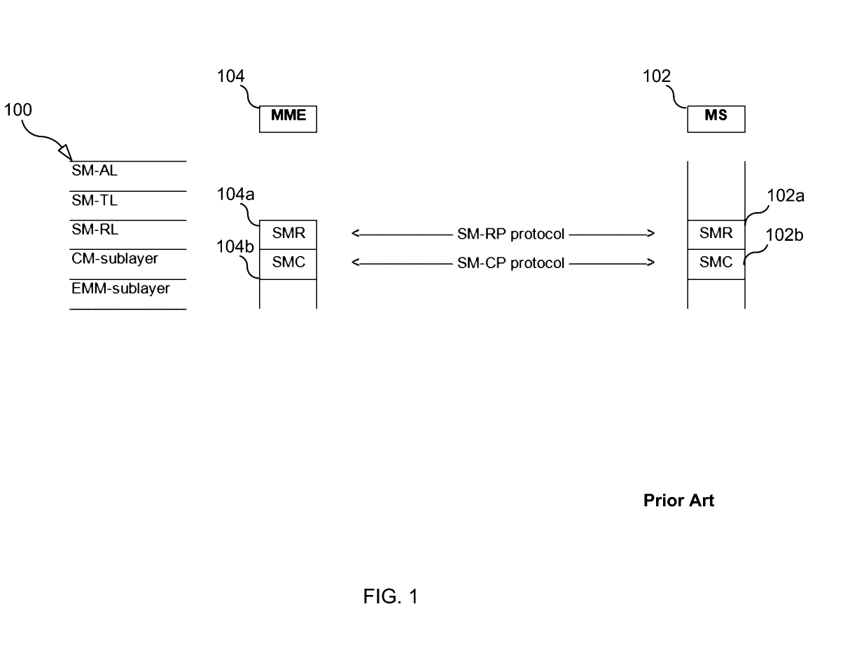

FIG. 2 is an illustration of a signal flow diagram.

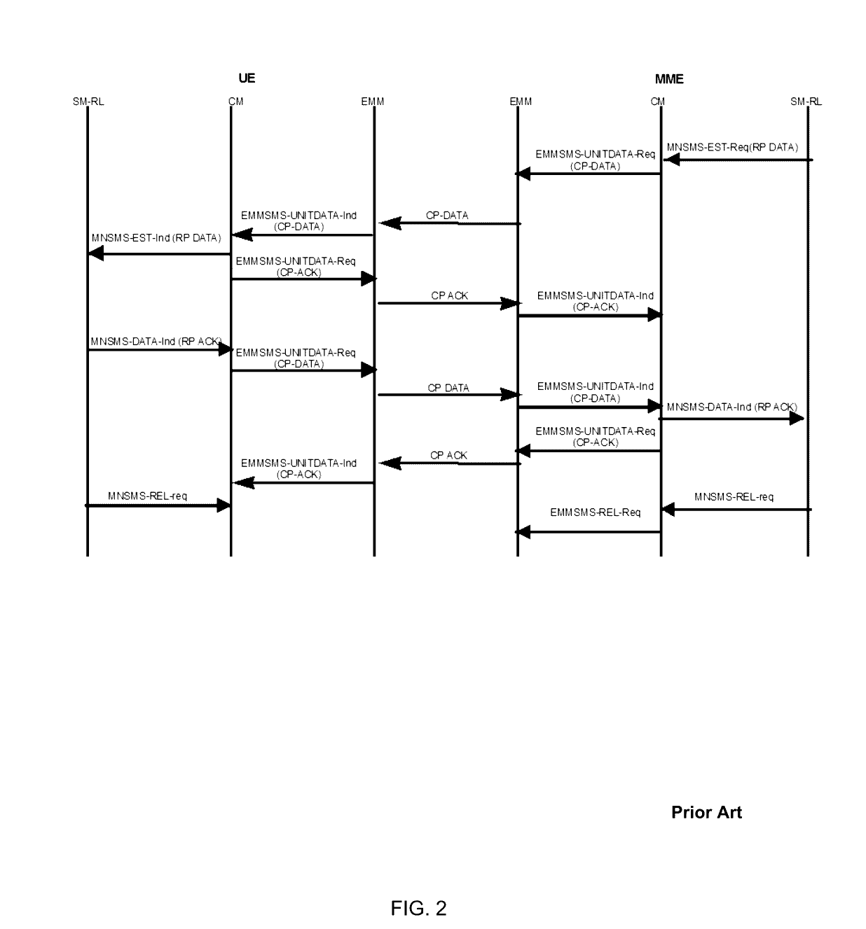

FIG. 3 is an illustration of a wireless communication topology.

FIG. 4 is an illustration of a wireless communication topology.

FIG. 5 is an illustration of an optimized SMS protocol stack.

FIG. 6 is an illustration of a signal flow diagram.

FIG. 7 is an illustration of a signal flow diagram.

FIG. 8 is an illustration of a signal flow diagram.

FIG. 9 is an illustration of a signal flow diagram.

FIG. 10 is an illustration of a flow chart.

FIG. 11 is an illustration of a flow chart.

FIG. 12 is an illustration of a control node.

FIG. 13 is an illustration of a UE.

FIG. 14 is an illustration of a CIoT device.

### DETAILED DESCRIPTION

According to some embodiments, two layers of the SMS protocol stack, the SM-RL (SM-RP protocol layer) and the CM-sublayer (SM-CP protocol layer) are replaced by one layer that is configured to relay SMS messages such as a Short Message Internet of Things Relay Layer (SM-IRL), or any other layer known to one of ordinary skill in the art that relays SMS messages. Furthermore, the EMM_sublayer, which is the lowest layer of the SMS protocol stack, may be replaced by a SmallData-sublayer (SD-sublayer).

In some embodiments, small data refers to a message or packet that is typically between 20 to 200 bytes. A small data message may in some implementations also have a larger upper limit e.g. 1 kilobyte. Some embodiments use small data delivery that will eventually be specified for CIoT devices to convey the SMS data between the CIoT device and the C-SGN/MME.

The embodiments disclosed herein provides the significantly advantageous features of legacy SMS services to constrained CIoT devices, taking advantage of new small data delivery specified for CIoT, therefore enabling implementation with a minimum signaling (e.g., no RP and CP layers) over the radio and a smaller footprint for the protocol stack on the device. Furthermore, by replacing the two legacy SMS layers (CP & RP) with one layer the number of messages over radio is reduced from four to at least two (or potentially one), thus optimizing the most inefficient parts of the SMS protocol stack that are used over the radio interface. Furthermore, the CIoT which utilizes ultra low bitrate communication can then receive or send SMS's with two or possibly one message instead of four messages. The message size may also be reduced. Additionally, UE's such as smartphones, tablets, etc. may implement the optimized SMS stack to achieve the smaller footprint and increased efficiency.

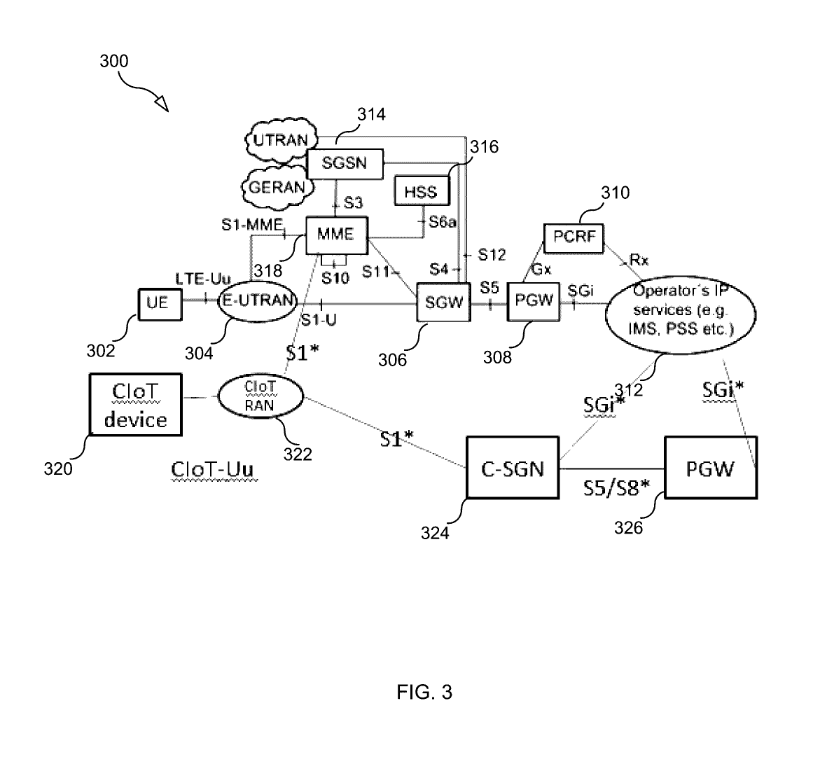

FIG. 3 illustrates an embodiment of a wireless communication system 300. The system may be called an LTE based system. It should be pointed out that the terms “LTE” and “LTE based” system is here used to comprise both present and future LTE based systems, such as, for example, advanced LTE systems and including systems using Radio Access Technologies (RAT) other than LTE based known to one of ordinary skill in the art.

It should be appreciated that although FIG. 3 shows a wireless communication system in the form of a LTE based system with new entities and interfaces added for CIoT, the example embodiments herein may also be utilized in connection with other wireless communication systems comprising nodes and functions that correspond to the nodes and functions of the system in FIG. 3.

In some embodiments, the communications system 300 includes a legacy system that has a user equipment (UE) 302, an Evolved Universal Terrestrial Radio Access Network (E-UTRAN) 304, a Serving Gateway (SGW) 306, a Packet Data Network Gateway (PGW) 308, a Policy Control and Charging Rules Function (PCRF) node 310, Operator's IP services 312, a Serving General Packet Radio Service Support Node (SGSN) 314), a Home Subscriber Server (HSS) 316, a Mobility Management Entity (MME) 318, and SGSN 314. The communications network 300 may further include an Internet-of-Things system that includes a CIoT device 320, a CIoT Radio Access Network (RAN) 322, a CIoT Serving Gateway Node (C-SGN) 324, and PGW 326. In the embodiments disclosed herein and eventual 3GPP standard, the CIoT device 320 may also be considered a UE 302, the CIoT RAN 322 also be considered a E-UTRAN 304, and the C-SGN 324 also be considered one or more of MME 318, SGW 306 and PGW 308. Such a general CIoT device, or CIoT RAN or C-SGN may in a specific case or deployment be equipped to only support a subset of the standard e.g. CIoT related functions and procedures.

In some embodiments, the UE 302 may be a mobile station (MS) or a similar wireless device, such as mobile phones, or cellular phones, or laptops or similar devices with wireless capability, and thus can be, for example, portable, pocket, hand-held, computer-comprised, or vehicle-mounted or other wireless devices which communicate voice and/or data with a radio access network. Wireless terminals may be embedded (e.g. as a card or a circuit arrangement or similar) in and/or attached to various other devices, e.g. such as various laptop computers or tablets or similar or other mobile consumer electronics or similar, or vehicles or boats or air planes or other movable devices, e.g. intended for transport purposes. Indeed, the radio terminal may even be embedded in and/or attached to various stationary or semi-stationary devices or Cellular Internet of Things devices, e.g. domestic appliances or similar, or consumer electronics such as printers or similar having a semi-stationary mobility character.

In a wireless communications network, wireless terminals communicate with one or more Core Networks (CNs) via one or more Radio Access Network(s) (RAN). The Radio Access Network (RAN) covers a geographical area which is divided into cell areas, with each cell area being served by a base station, e.g. a Radio Base Station (RBS). In some radio access networks the base station is e.g. called “NodeB” or “B node” or enhanced NodeB (eNB). A cell is a geographical area where radio coverage is provided by the equipment of a radio base station at a base station site. Each cell is identified by an identity within the local radio area, which may be broadcasted in the cell. The base stations communicate via an air interface with radio terminals within range of the base stations.

In some versions of the RAN, several base stations are typically connected, e.g. by landlines or microwave links, to a Radio Network Controller (RNC) or a Base Station Controller (BSC) or similar. The radio network controller or similar supervises and coordinates various activities of the plural base stations connected thereto. The radio network controllers are typically connected to one or more core networks.

Typically the Core Network (CN), to which the wireless terminal communicates via the RAN, comprises a number of core network nodes. Examples of core network nodes are the SGW 306, PCRF 310, the HSS 316, and the SGSN 314.

In FIG. 3, the E-UTRAN 304 corresponds to the Radio Access Network (RAN), which may comprise a number of radio access nodes in the form of eNodeBs (eNB) that interfaces with UE 302. Several UEs are normally served by one eNB. However, for the sake of simplicity only one UE is illustrated in FIG. 3

In some embodiments, the SGW 306 routes and forwards user data packets, while also acting as the mobility anchor for the user plane during inter-eNB handovers and as the anchor for mobility between LTE and other 3GPP technologies (terminating S4 interface and relaying the traffic between 2G/3G systems and PDN GW). For idle state UEs, the SGW terminates the DL data path and triggers paging when DL data arrives for the UE. It manages and stores UE contexts, e.g. parameters of the IP bearer service, network internal routing information. It also performs replication of the user traffic in case of lawful interception.

In some embodiments, the MME 318 is the key control-node for the LTE access-network. It is responsible for idle mode UE tracking and paging procedure including retransmissions. It is involved in the bearer activation/deactivation process and is also responsible for choosing the SGW for a UE at the initial attach and at time of intra-LTE handover involving Core Network (CN) node relocation. It is responsible for authenticating the user (by interacting with the HSS). The Non-Access Stratum (NAS) signaling terminates at the MME and it is also responsible for generation and allocation of temporary identities to UEs. It checks the authorization of the UE to camp on the service provider's Public Land Mobile Network (PLMN) and enforces UE roaming restrictions. The MME is the termination point in the network for ciphering/integrity protection for NAS signaling and handles the security key management. Lawful interception of signaling is also supported by the MME. The MME also provides the control plane function for mobility between LTE and 2G/3G access networks with the S3 interface terminating at the MME from the SGSN. The MME also terminates the S6a interface towards the home HSS for roaming UEs

In some embodiments, the PDN Gateway (PGW) is a network gateway node that provides connectivity for the UE to one or more external Packet Data Networks (PDNs) 250 by being the point of exit and entry of traffic for the UE. A UE may have simultaneous connectivity with more than one PGW for accessing multiple PDNs. The PGW performs policy enforcement, packet filtering for each user, charging support, lawful Interception and packet screening. Another key role of the PGW is to act as the anchor for mobility between 3GPP and non-3GPP technologies such as WiMAX and 3GPP2 (CDMA 1× and EvDO).

In some embodiments, HSS 316 is a database that contains user-related and subscriber-related information. It also provides support functions in mobility management, call and session setup, user authentication and access authorization.

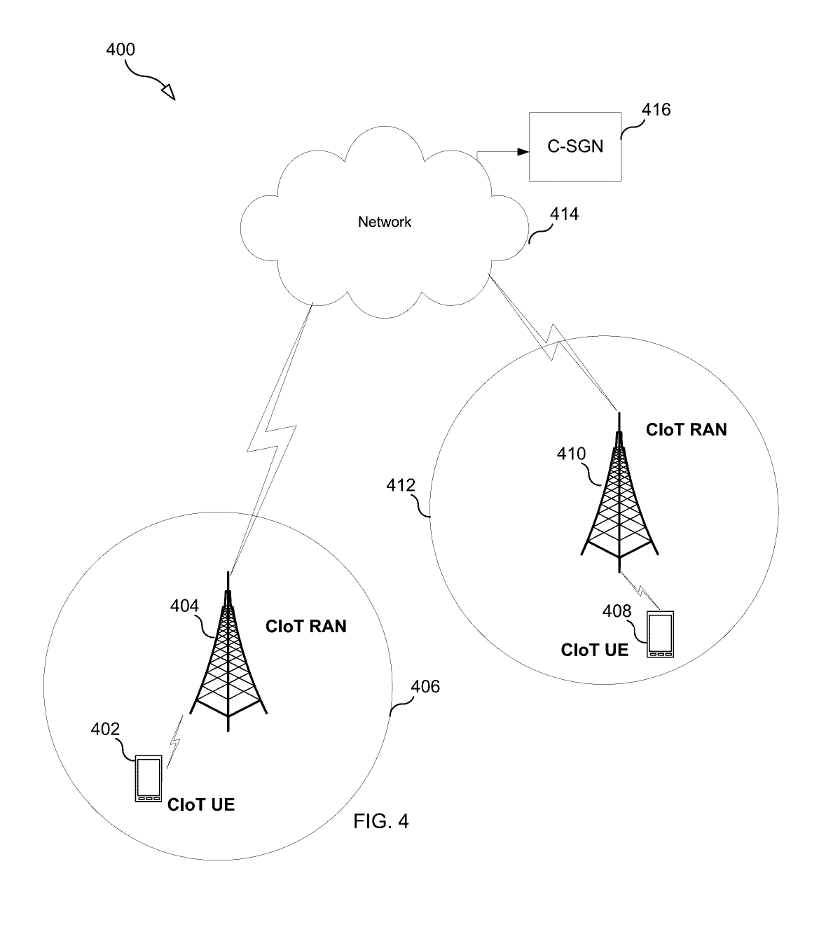

FIG. 4 illustrates an embodiment of an IoT network 400. The IoT network 400 includes a first cell 406 that has a CIoT RAN 404 and CIoT UE 402. The IoT 400 may further include a second cell 412 that includes a CIoT RAN 410, and CIoT UE 408. Although only one CIoT UE is illustrated in cells 406 and 412, as understood by one of ordinary skill in the art, multiple CIoT UE's may be located in each of these cells. The CIoT RAN 404 and 410 may be connected to a network 414 that is connected to network node 416 such as a C-SGN. The network 414 is the Core Network.

According to some embodiments, the optimized SMS relay replaces two of the layers (the SM-RL and the CM-sublayer) with one layer such as the SM-IRL. The SM-IRL consists of a Short Message Internet-of-Things Relay Protocol (SM-IRP) that uses the SD-sublayer. This optimized SMS relay minimizes the signaling over the radio and reduces the complexity and footprint in the CIoT device.

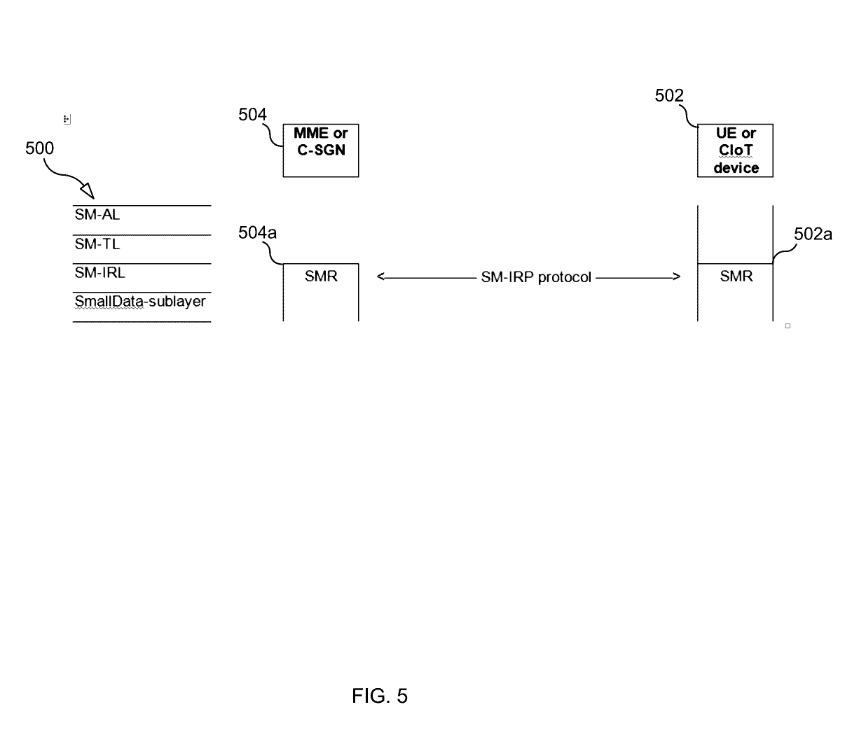

FIG. 5 illustrates an optimized SMS protocol stack 500 that includes the SM-AL, SM-TL, SM-IRL, and a sub-layer such as the SD-sublayer or the EMM-sublayer. As illustrated in FIG. 5, a UE or CIoT device 502 may communicate with an MME or C-SGN 504, respectively with respective SMS layers 502a and 504a that communicate with the SM-IRP protocol. In some embodiments, a single SM-IRP protocol is used. In some embodiments, only one sub-layer is used by the SM-IRL or any other layer that that transfers SMS messages.

The SM-IRP protocol layer may either use a SD-sublayer or an EMM-sublayer. In some embodiments, the SD-sublayer uses a small data delivery protocol to convey the SMS data between the CIoT device 502 and the C-SGN/MME 504. The EMM-sublayer is the legacy way of sending SMS as specified in the TS 24.011 and TS 23.040 and TS 24.301, the entire contents of both of which are incorporated herein by reference. In some embodiments, the SM-IRP implements the service primitives needed by the SM transfer later (SM-TL) in the UE/CIoT device and in the MME/C-SGN.

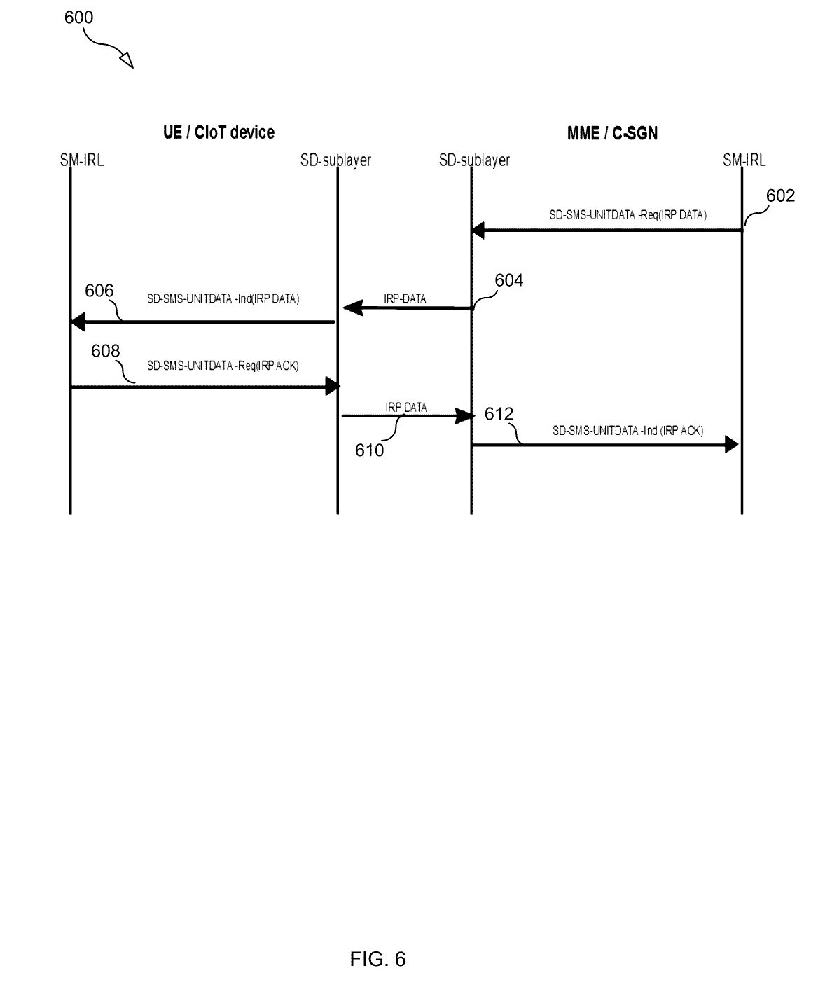

FIG. 6 illustrates an embodiment of a signal flow diagram 600 for data received by a mobile device such as a mobile terminated SMS (MT-SMS). As illustrated in FIG. 6, the signal flow is between a wireless communication device (WCD)(e.g., UE, CIoT device) and a control node (e.g., MME, C-SGN) each of which implements an optimized SMS protocol stack that has a relay layer (e.g., SM-IRL) that also realizes connection related functions as needed and that may use a new sub-layer (e.g., SD-sublayer). In some embodiments, data is transferred in accordance with the SM-IRP protocol. For example, data is transferred between the WCD and the control node using IRP-DATA, which is the Protocol Data Unit (PDU) of the SM-IRP protocol. The SM-IRP protocol uses a small header which code necessary protocol primitives.

Step 602. IRP-DATA corresponding to data intended for the WCD is transferred from the SM-IRL of a control node using service primitives of the SD-sublayer of the control node. The SD-sublayer further conveying the received data as IRP-DATA.

Step 604. The IRP-DATA corresponding to the data intended for the WCD is transferred from the SD-sublayer of the control node to the SD-sublayer of a WCD. This may involve a service request procedure depending on the internal SD-sublayer implementation (see step 704 below).

Step 606. The IRP-DATA is transferred from the SD-sublayer of the WCD to the SM-IRL of the WCD.

Step 608. An IRP-ACK corresponding to an acknowledgement of reception of the IRP-DATA is transferred from the SM-IRL of the WCD to the SD-sublayer of the WCD.

Step 610. IRP-DATA corresponding to the IRP-ACK is transferred between the SD-sublayer of the WCD to the SD-sublayer of the control node.

Step 612. The IRP-ACK is transferred from the SD-sublayer of the control node to the SM-IRL of the control node, thereby completing the MT-SMS signal flow for data received by the WCD.

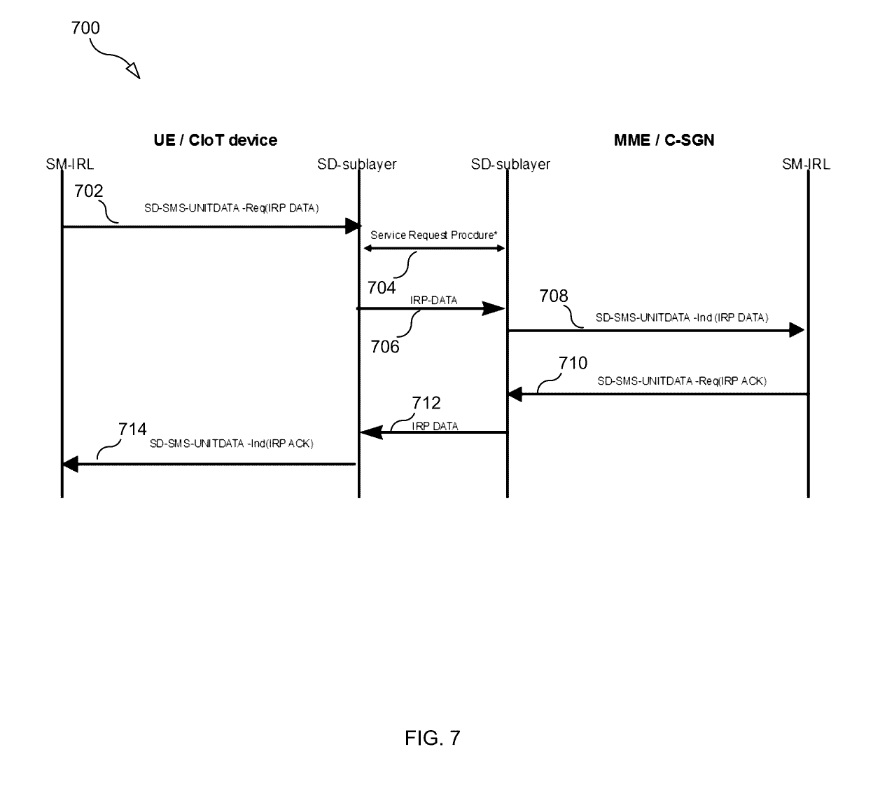

FIG. 7 illustrates an embodiment of a signal flow diagram 700 for data originated by a mobile device such as a mobile originated SMS (MO-SMS). As illustrated in FIG. 7, the signal flow is between a WCD (e.g., UE, CIoT device) and a control node (e.g., MME, C-SGN) each of which implements an optimized SMS protocol stack that has a relay layer (e.g., SM-IRL) that also realizes connection related functions as needed and that may use a new sub-layer (e.g., SD-sublayer).

Step 702. IRP-DATA corresponding to data originated by the WCD is transferred from the SM-IRL of the WCD to the SD-sublayer of the WCD.

Step 704. In response to receiving the IRP-DATA, a service request procedure may depending on the internal SD-sublayer implementation be performed between the SD-sublayer of the WCD and the SD-sublayer of the control node. With the current solutions proposed in the TR 23.720 a service request as step 704 may not be needed as most candidates for small data propose to use a signaling connection for transmission of small data, as opposed to establishing an MM-connection for conventional SMS. Step 706. IRP-DATA corresponding to the WCD originated data is transferred between the SD-sublayer of the WCD and the SD-sublayer of the control node.

Step 708. IRP-DATA corresponding to the WCD originated data is transferred between the SD-sublayer of the control node to the SM-IRL of the control node.

Step 710. An IRP-ACK corresponding to an acknowledgement of receiving the IRP-Data is transferred between the SM-IRL of the control node to the SD-sublayer of the control node.

Step 712. IRP-DATA corresponding to the IRP-ACK is transferred between the SD-sublayer of the control node and the SD-sublayer of the WCD.

Step 714. The IRP-ACK is transferred between the SD-sublayer of the WCD and the SM-IRL of the WCD, thereby completing the signal flow of the WCD originated data.

As illustrated in FIGS. 6 and 7, only two SD-DATA messages are used between the SD-sublayer in the control node and the SD-sublayer in the WCD to convey either a MO-SMS or a MT-SMS. In further embodiments, only one SD-DATA message is used if the lower layers used by the SD-sublayer (e.g. S1AP-FRRC) acknowledge a successful data transfer to the WCD. That is, the IRP-DATA carrying the IRP-ACK would then not be needed in respective figure (i.e. at least 610, 712 and 608, 612, 710, 714 may then be omitted).

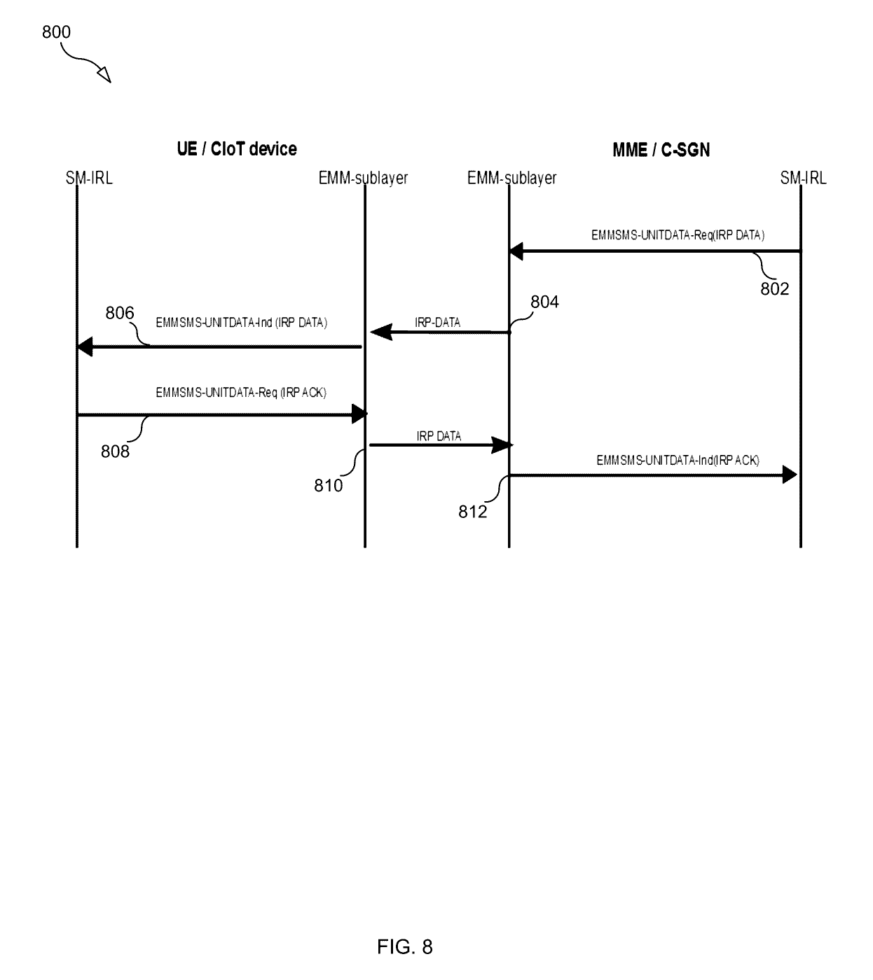

FIG. 8 illustrates an embodiment of a signal flow diagram 800 for data received by a mobile device such as a mobile terminated SMS (MT-SMS). FIG. 8 illustrates a similar procedure as illustrated in FIG. 6, except that the SD-sublayer is replaced by the EMM-sublayer. As illustrated in FIG. 8, the signal flow is between a WCD (e.g., UE, CIoT device) and a control node (e.g., MME, C-SGN) each of which implements an optimized SMS protocol stack that has a relay layer (e.g., SM-IRL) that also realizes connection related functions as needed and that may use a conventional sub-layer (e.g., EMM-sublayer). Depending on decisions in the 3GPP, a SM-IRP protocol may be designed and standardized to use either a small data sublayer (SD-sublayer) or a EMM-sublayer or both. If both will be possible, it may depend on the certain network deployment which one is used.

Step 802. IRP-DATA corresponding to data intended for the WCD is transferred from the SM-IRL of a control node to the EMM-sublayer of the control node.

Step 804. The IRP-DATA corresponding to the data intended for the WCD is transferred from the EMM-sublayer of the control node to the EMM-sublayer of a WCD.

Step 806. The IRP-DATA is transferred from the EMM-sublayer of the WCD to the SM-IRL of the WCD.

Step 808. An IRP-ACK corresponding to an acknowledgement of reception of the IRP-DATA is transferred from the SM-IRL of the WCD to the EMM-sublayer of the WCD.

Step 810. IRP-DATA corresponding to the IRP-ACK is transferred between the EMM-sublayer of the WCD to the EMM-sublayer of the control node.

Step 812. The IRP-ACK is transferred from the EMM-sublayer of the control node to the SM-IRL of the control node, thereby completing the MT-SMS signal flow for data received by the WCD.

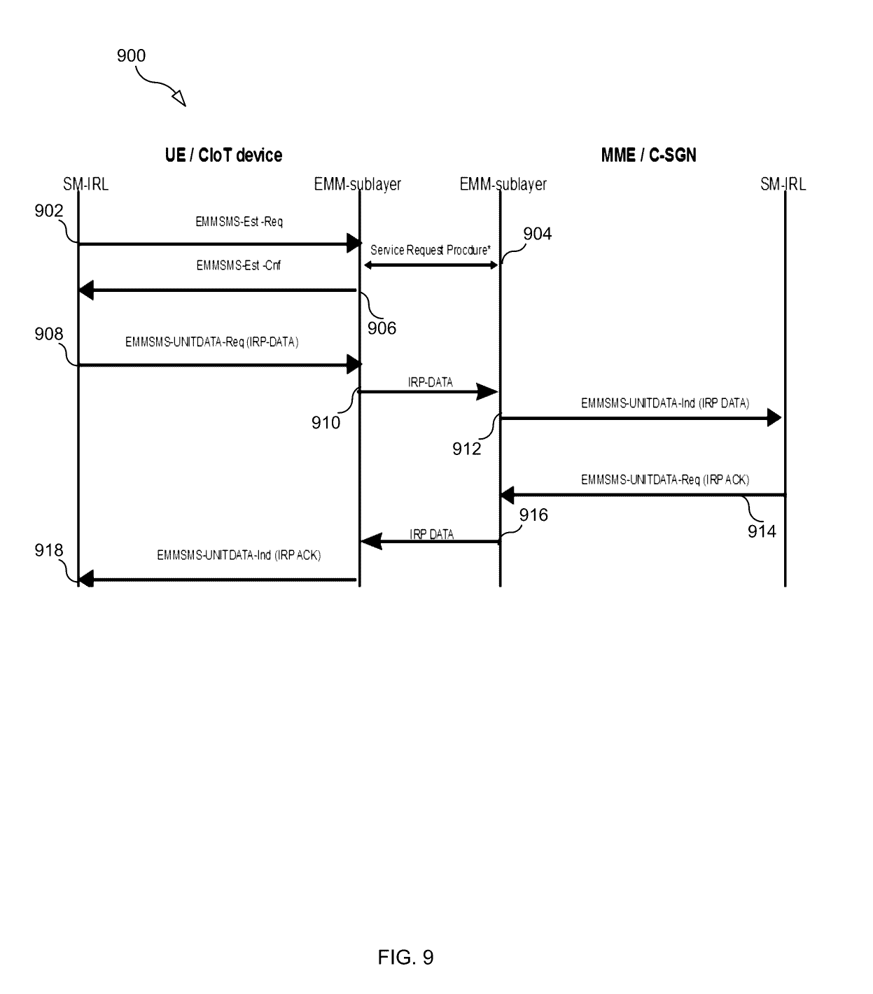

FIG. 9 illustrates an embodiment of a signal flow diagram 900 for data originated by a mobile device such as a mobile originated SMS (MO-SMS). As illustrated in FIG. 9, the signal flow is between a WCD (e.g., UE, CIoT device) and a control node (e.g., MME, C-SGN) each of which implements an optimized SMS protocol stack that has a relay layer (e.g., SM-IRL) that also realizes connection related functions as needed and that may use a conventional sub-layer (e.g., EMM-sublayer). Depending on decisions in the 3GPP, a SM-IRP protocol may be designed and standardized to use either a small data sublayer (SD-sublayer) or an EMM-sublayer or both. If both will be possible, it may depend on the certain network deployment which one is used.

Step 902. EMM request data is transferred from the SM-IRL of the WCD to the EMM-sublayer of the WCD.

Step 904. In response to receiving the EMM request data, a service request procedure is performed between the EMM-sublayer of the WCD and the EMM-sublayer of the control node. Depending on characteristics of the EMM-sublayer in RAN supporting CIoT, the service request may not be needed. In that case, steps 902, 904 and step 906 may be omitted for MO-SMS in this figure.

Step 906. In response to completion of the service request procedure, an EMM confirmation is transferred between the EMM-sublayer of the WCD and the SM-IRL of the WCD.

Step 908. In response to the receiving the EMM confirmation, IRP-DATA corresponding to data originated by the WCD is transferred from the SM-IRL of the WCD to the EMM-sublayer of the WCD.

Step 910. IRP-DATA corresponding to the WCD originated data is transferred between the EMM-sublayer of the WCD and the EMM-sublayer of the control node.

Step 912. IRP-DATA corresponding to the WCD originated data is transferred between the EMM-sublayer of the control node to the SM-IRL of the control node.

Step 914. An IRP-ACK corresponding to an acknowledgement of receiving the IRP-Data is transferred between the SM-IRL of the control node to the EMM-sublayer of the control node.

Step 916. IRP-DATA corresponding to the IRP-ACK is transferred between the EMM-sublayer of the control node and the EMM-sublayer of the WCD.

Step 918. The IRP-ACK is transferred between the EMM-sublayer of the WCD and the SM-IRL of the WCD, thereby completing the signal flow of the WCD originated data.

As illustrated in FIGS. 8 and 9 only two IRP-DATA messages are used between the EMM-sublayer in the control node and the EMM-sublayer in the WCD to convey one MO-SMS or MT-SMS. In further embodiments, only one IRP-DATA message is used if the lower layers used by the EMM-sublayer can acknowledge a successful data transfer to the WCD. That is, the IRP-DATA carrying the IRP-ACK would then not be needed in respective figure (i.e. at least 810, 916 and 808, 812, 914, 918 may then be omitted).

According to some embodiments, the WCD (e.g., UE/CIoT device) uses a SM-IRL layer and associated relay protocol (SM-IRP protocol) for SMS services. In some embodiments, the SM-IRL layer uses a SD-sublayer which provides service primitives for relaying SMSes and where the SD-sublayer is based on small data delivery mechanisms specified for CIoT. The application in the UE/CIoT device uses, the SM-AL which uses the SM-TL which in turn uses the SM-IRL relay layer to relay SMS's to/from the network.

According to some embodiments, the control node (e.g., MME/C-SGN) uses a SM-IRL layer and associated relay protocol (SM-IRP protocol) for SMS services. In some embodiments, the SM-IRL layer uses a SD-sublayer which provides service primitives for relaying SMSes and where the SD-sublayer is based on small data delivery mechanisms specified for CIoT. SMS's conveyed by the MME/C-SGN (e.g. using the SGd and SGs interfaces), uses the SM-IRL relay layer and associated relay protocol (SM-IRP protocol) to relay SMS's to/from UE/CIoT devices.

In some embodiments, a header is used to distinguish SMS messages from other small data sent over the sub-layer used to convey small data for CIoT devices. In some embodiments, the header for a MO-SMS is added by the WCD and removed by the control node. In some embodiments, the header for a MT-SMS is added by the control node and removed by the wireless communication device.

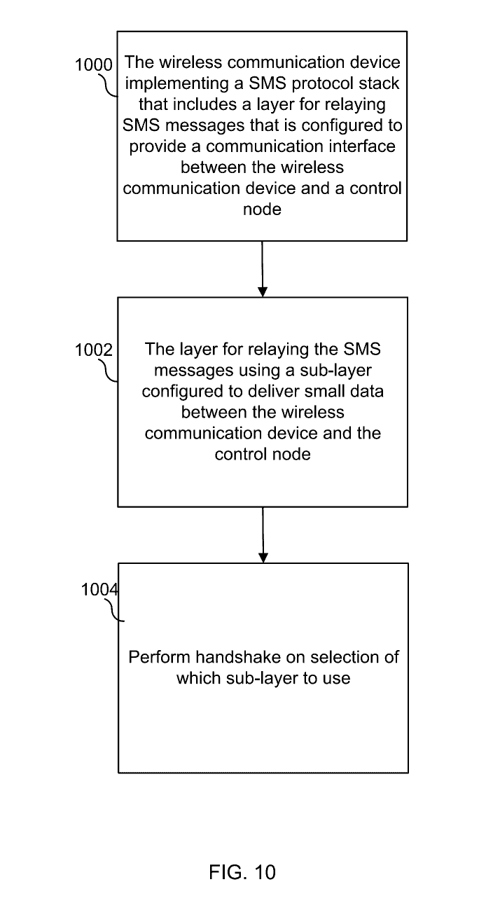

FIG. 10 illustrates an embodiment of a process performed by a WCD. The process may start at step 1000 where the WCD implements a SMS protocol stack that includes a layer for relaying SMS messages that is configured to provide a communication interface between the wireless communication device and a control node. In step 1002, the layer for relaying SMS messages uses a sub-layer configured to deliver small data between the WCD and the control node. In some embodiments, the WCD has the option of selecting either the SD-sublayer, the EMM-sublayer, or both sub-layers.

In one further embodiment, at step 1004, for the case where both a SD-sublayer and an EMM-sublayer are possible alternatives for an SM-IRL, a handshake of which sublayer to use (i.e. SD-sublayer or EMM-sublayer) for conveying SMSes, is done as part of the WCD attachment to the network. Optionally a selected sublayer may be reselected at a later stage by doing a new handshake using some NAS messaging between the WCD and the control node (e.g. TAU request and TAU response).

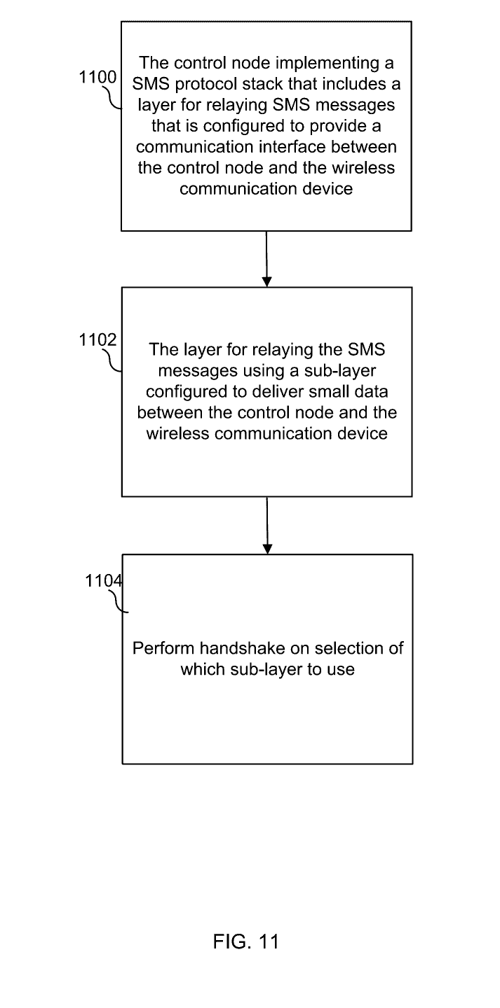

FIG. 11 illustrates an embodiment of a process performed by a control node. The process may start at step 1100 where the control node implements a SMS protocol stack that includes a layer for relaying SMS messages that is configured to provide a communication interface between the control node and a wireless communication device. In step 1102, the layer for relaying the SMS messages using a sub-layer which is configured to deliver small data between the control node and the wireless communication device. In some embodiments, the control node has the option of selecting either the SD-sublayer, the EMM-sublayer, or both sub-layers.

In one further embodiment, at step 1104, for the case where both a SD-sublayer and an EMM-sublayer are possible alternatives for an SM-IRL, a handshake of which sublayer to use (i.e. SD-sublayer or EMM-sublayer) for conveying SMSes, is done when a WCD attaches to the network. Optionally a selected sublayer may be reselected at a later stage by doing a new handshake using some NAS messaging between the WCD and the control node (e.g. initiated by the WCD using a TAU request and TAU response).

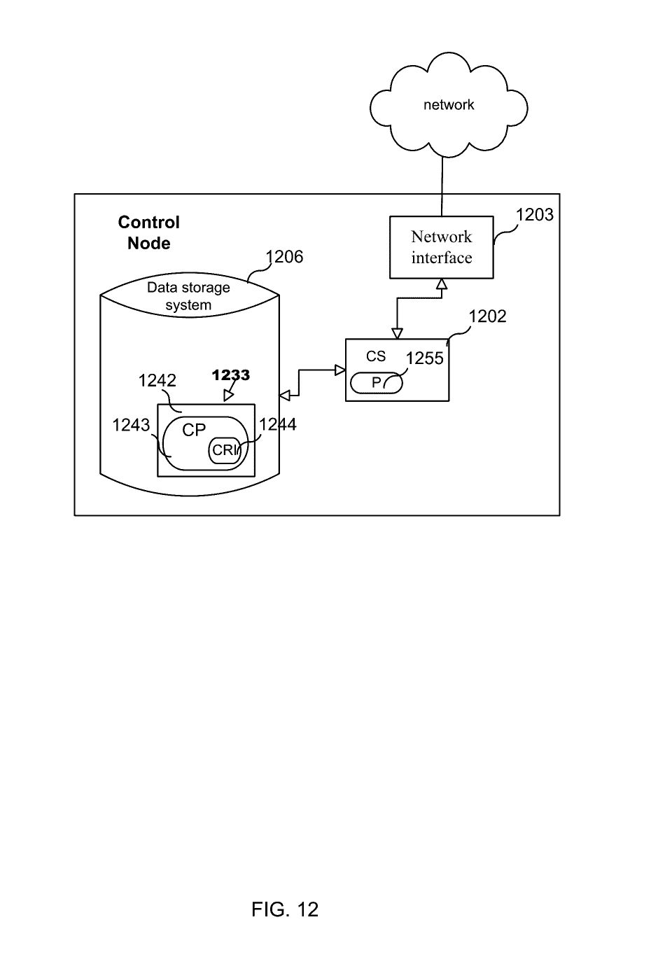

FIG. 12 is a block diagram of an embodiment of a control node such as a MME of C-SGN. As shown in FIG. 12, the control node may include or consist of: a computer system (CS) 1202, which may include one or more processors 1255 (e.g., a general purpose microprocessor) and/or one or more circuits, such as an application specific integrated circuit (ASIC), field-programmable gate arrays (FPGAs), a logic circuit, and the like; a network interface 1203 for use in connecting the control node to a network; and a data storage system 1206, which may include one or more non-volatile storage devices and/or one or more volatile storage devices (e.g., random access memory (RAM)). In embodiments where the control node includes a processor 1255, a computer program product (CPP) 1233 may be provided. CPP 1233 includes or is a computer readable medium (CRM) 1242 storing a computer program (CP) 1243 comprising computer readable instructions (CRI) 1244. CRM 1242 is a non-transitory computer readable medium, such as, but not limited, to magnetic media (e.g., a hard disk), optical media (e.g., a DVD), solid state devices (e.g., random access memory (RAM), flash memory), and the like. In some embodiments, the CRI 1244 of computer program 1243 is configured such that when executed by computer system 1202, the CRI causes the control node to perform steps described above (e.g., steps described above with reference to the flow charts and message flows shown in the drawings). In other embodiments, the control node may be configured to perform steps described herein without the need for a computer program. That is, for example, computer system 1202 may consist merely of one or more ASICs. Hence, the features of the embodiments described herein may be implemented in hardware and/or software.

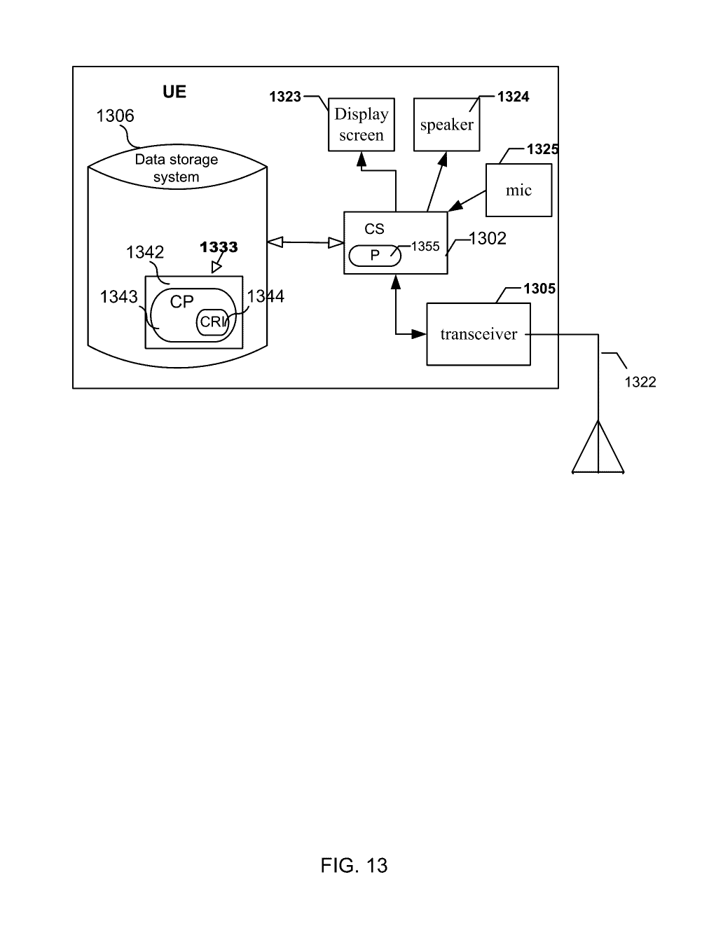

FIG. 13 is a block diagram of a UE according to some embodiments. As shown in FIG. 13, the UE may include or consist of: a computer system (CS) 1302, which may include one or more processors 1355 (e.g., a general purpose microprocessor) and/or one or more circuits, such as an application specific integrated circuit (ASIC), field-programmable gate arrays (FPGAs), a logic circuit, and the like; a transceiver 1305, coupled to an antenna, 1322 for transmitting and receiving data wireless; and a data storage system 1306, which may include one or more non-volatile storage devices and/or one or more volatile storage devices (e.g., random access memory (RAM)). In embodiments where the UE includes a processor 1355, a computer program product (CPP) 1333 may be provided. CPP 1333 includes or is a computer readable medium (CRM) 1342 storing a computer program (CP) 1343 comprising computer readable instructions (CRI) 1344. CRM 1342 is a non-transitory computer readable medium, such as, but not limited, to magnetic media (e.g., a hard disk), optical media (e.g., a DVD), solid state devices (e.g., random access memory (RAM), flash memory), and the like. In some embodiments, the CRI 1344 of computer program 1343 is configured such that when executed by computer system 1302, the CRI causes the UE to perform steps described above (e.g., steps described above with reference to the flow charts and message flows shown in the drawings). In other embodiments, the UE may be configured to perform steps described herein without the need for a computer program. That is, for example, computer system 1302 may consist merely of one or more ASICs. Hence, the features of the embodiments described herein may be implemented in hardware and/or software. As shown in FIG. 13, the UE may include: a display screen 1333, a speaker 1324, and a microphone (“mica”), all of which are coupled to CS 1302.

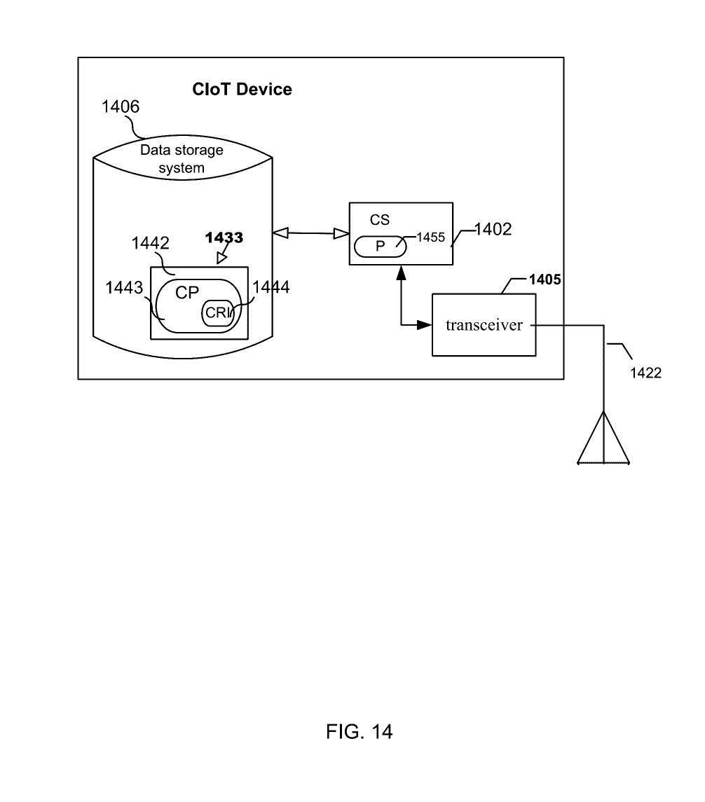

FIG. 14 is a block diagram of a CIoT device according to some embodiments. As shown in FIG. 14, the CIoT device may include or consist of: a computer system (CS) 1402, which may include one or more processors 1455 (e.g., a general purpose microprocessor) and/or one or more circuits, such as an application specific integrated circuit (ASIC), field-programmable gate arrays (FPGAs), a logic circuit, and the like; a transceiver 1405, coupled to an antenna, 1422 for transmitting and receiving data wireless; and a data storage system 1406, which may include one or more non-volatile storage devices and/or one or more volatile storage devices (e.g., random access memory (RAM)). In embodiments where the CIoT device includes a processor 1455, a computer program product (CPP) 1433 may be provided. CPP 1433 includes or is a computer readable medium (CRM) 1442 storing a computer program (CP) 1443 comprising computer readable instructions (CRI) 1444. CRM 1442 is a non-transitory computer readable medium, such as, but not limited, to magnetic media (e.g., a hard disk), optical media (e.g., a DVD), solid state devices (e.g., random access memory (RAM), flash memory), and the like. In some embodiments, the CRI 1444 of computer program 1443 is configured such that when executed by computer system 1402, the CRI causes the CIoT device to perform steps described above (e.g., steps described above with reference to the flow charts and message flows shown in the drawings). In other embodiments, the CIoT device may be configured to perform steps described herein without the need for a computer program. That is, for example, computer system 1402 may consist merely of one or more ASICs. Hence, the features of the embodiments described herein may be implemented in hardware and/or software.

### Concise Description of Embodiments

A1. A method performed in a wireless communication device, the method comprising:

the wireless communication device implementing a Short Message Service (SMS) protocol stack that includes a layer for relaying SMS messages that is configured to provide a communication interface between the wireless communication device and a control node; and

the layer for relaying SMS messages using a sub-layer configured to deliver small data between the wireless communication device and the control node.

A2. The method according to embodiment A1, further comprising:

receiving, via the sub-layer from the control node, a mobile terminated SMS (MT-SMS) message.

A3. The method according to embodiment A2, further comprising:

transmitting, via the sub-layer to the control node in response to receiving the MT-SMS message, an acknowledgement to the MT-SMS message.

A4. The method according to embodiment A1, further comprising:

transmitting, via the sub-layer to the control node, a mobile originated SMS (MO-SMS) message

A5. The method according to embodiment A4, further comprising:

receiving, via the sub-layer from the control node in response to transmitting the MO-SMS message, an acknowledgement to the MO-SMS message.

A6. The method according to embodiment A1, wherein the SMS protocol stack further includes a Short Message Application Layer (SM-AL) and a Short Message Transport Layer (SM-TL) that are higher in the protocol stack with respect to the layer for relaying SMS messages, wherein the layer for relaying SMS messages provides at least one service primitive required by the SM-TL.

A7. The method according to embodiment A1, wherein the sub-layer is a layer used to convey small data for Cellular Internet-of-Things devices.

A8. The method according to embodiment A1, wherein the sub-layer is an Evolved Packet System Mobility Management (EMM) sub-layer.

A9. The method according to embodiment A1, wherein the WCD selects the sub-layer being one of a layer used to convey small data for Cellular Internet-of-Things devices and an Evolved Packet System Mobility Management (EMM) sub-layer.

A10. The method according to embodiment A1, wherein a header is used to distinguish SMS messages from other small data sent over the sub-layer used to convey small data for Cellular Internet-of-Things (CIoT) devices, and

wherein the header for a mobile originated (MO) SMS is added in the wireless communication device and removed by the control node, and

wherein the header for a mobile terminated (MT) SMS is added by the control node and removed by the wireless communication device.

A11. The method according to embodiment A1, wherein the wireless communication device is a mobile terminal.

A12. The method according to embodiment A1, wherein the wireless communication device is a Cellular Internet of Things (CIoT) device.

A13. The method according to embodiment A1, wherein the control node is a Mobility Management Entity (MME) node.

A14. The method according to embodiment A1, wherein the control node is a Cellular Internet of Things Serving Gateway Node (C-SGN).

A15. A method performed in a control node, the method comprising:

the control node implementing a Short Message Service (SMS) protocol stack that includes a layer for relaying SMS messages that is configured to provide a communication interface between the control node and a wireless communication device; and

the layer for relaying SMS messages using a sub-layer which is configured to deliver small data between the control node and the wireless communication device.

A16. The method according to embodiment A15, further comprising:

transmitting, via the sub-layer to the wireless communication device, a mobile terminated SMS (MT-SMS) message

A17. The method according to embodiment A16, further comprising:

receiving, via the sub-layer from the wireless communication device in response to transmitting the MT-SMS message, an acknowledgement to the MT-SMS message.

A18. The method according to embodiment A15, further comprising:

receiving, via the sub-layer from the wireless communication device, a mobile originated SMS (MO-SMS) message

A19. The method according to embodiment A18, further comprising:

transmitting, via the sub-layer from the wireless communication device in response to receiving the MO-SMS message, an acknowledgement to the MO-SMS message.

A20. The method according to embodiment A15, wherein the SMS protocol stack further includes a Short Message Application Layer (SM-AL) and a Short Message Transport Layer (SM-TL) that are higher in the protocol stack with respect to the layer for relaying SMS messages, wherein the layer for relaying SMS messages provides at least one service primitive required by the SM-TL.

A21. The method according to embodiment A15, wherein the sub-layer is a layer used to convey small data for Cellular Internet-of-Things (CIot) devices.

A22. The method according to embodiment A15, wherein the sub-layer is an Evolved Packet System Mobility Management (EMM) sub-layer.

A23. The method according to embodiment A15, wherein the control node selects the sub-layer being one of a layer used to convey small data for Cellular Internet-of-Things devices and an Evolved Packet System Mobility Management (EMM) sub-layer.

A24. The method according to embodiment A15, wherein a header is used to distinguish SMS messages from other small data sent over the sub-layer used to convey small data for Cellular Internet-of-Things (CIoT) devices; and

wherein the header for a mobile originated (MO) SMS is added in the wireless communication device and removed by the control node, and

wherein the header for a mobile terminated (MT) SMS is added by the control node and removed by the wireless communication device.

A25. The method according to embodiment A15, wherein the wireless communication device is a mobile terminal.

A26. The method according to embodiment A15, wherein the wireless communication device is a Cellular Internet of Things (CIoT) device.

A27. The method according to embodiment A15, wherein the control node is a Mobility Management Entity (MME) node.

A28. The method according to embodiment A15, wherein the control node is a Cellular Internet of Things Serving Gateway Node (C-SGN).

A29. A wireless communication device (WCD) comprising:

a processor;

a computer readable medium coupled to the processor, said computer readable medium containing instructions executable by the processor, whereby the WCD is operative to:
implement a Short Message Service (SMS) protocol stack that includes a layer for relaying SMS messages that is configured to provide a communication interface between the wireless communication device and a control node, and
the layer for relaying SMS messages using a sub-layer configured to deliver small data between the wireless communication device and the control node.

A30. The WCD according to embodiment A29, wherein the WCD is further operative to:

receive, via the sub-layer from the control node, a mobile terminated SMS (MT-SMS) message.

A31. The WCD according to embodiment A30, wherein the WCD is further operative to:

transmit, via the sub-layer to the control node in response to receiving the MT-SMS message, an acknowledgement to the MT-SMS message.

A32. The WCD according to embodiment A29, wherein the WCD is further operative to:

transmit, via the sub-layer to the control node, a mobile originated SMS (MO-SMS) message

A33. The WCD according to embodiment A32, wherein the WCD is further operative to:

receive, via the sub-layer from the control node in response to transmitting the MO-SMS message, an acknowledgement to the MO-SMS message.

A34. The WCD according to embodiment A29, wherein the SMS protocol stack further includes a Short Message Application Layer (SM-AL) and a Short Message Transport Layer (SM-TL) that are higher in the protocol stack with respect to the layer for relaying SMS messages, wherein the layer for relaying SMS messages provides at least one service primitive required by the SM-TL.

A35. The WCD according to embodiment A29, wherein the sub-layer is a layer used to convey small data for Cellular Internet-of-Things devices.

A36. The WCD according to embodiment A29, wherein the sub-layer is an Evolved Packet System Mobility Management (EMM) sub-layer.

A37. The WCD according to embodiment A36, wherein the WCD selects the sub-layer being one of a layer used to convey small data for Cellular Internet-of-Things devices and an Evolved Packet System Mobility Management (EMM) sub-layer.

A38. The WCD according to embodiment A29, wherein a header is used to distinguish SMS messages from other small data sent over the sub-layer used to convey small data for Cellular Internet-of-Things (CIoT) devices, and

wherein the header for a mobile originated (MO) SMS is added in the wireless communication device and removed by the control node, and

wherein the header for a mobile terminated (MT) SMS is added by the control node and removed by the wireless communication device.

A39. The WCD according to embodiment A29, wherein the WCD is a mobile terminal.

A40. The WCD according to embodiment A29, wherein the WCD is a Cellular Internet of Things (CIoT) device.

A41. The WCD according to embodiment A29, wherein the WCD is a Mobility Management Entity (MME) node.

A42. The WCD according to embodiment A29, wherein the WCD is a Cellular Internet of Things Serving Gateway Node (C-SGN).

A43. A control node comprising:

a processor;

a computer readable medium coupled to the processor, said computer readable medium containing instructions executable by the processor, whereby the control node is operative to:
implement a Short Message Service (SMS) protocol stack that includes a layer for relaying SMS messages that is configured to provide a communication interface between the control node and a wireless communication device, and
the layer for relaying SMS messages using a sub-layer which is configured to deliver small data between the control node and the wireless communication device.

A44. The control node according to embodiment A43, wherein the control node is further operative to:

transmit, via the sub-layer to the wireless communication device, a mobile terminated SMS (MT-SMS) message

A45. The control node according to embodiment A44, wherein the control node is further operative to:

receive, via the sub-layer from the wireless communication device in response to transmitting the MT-SMS message, an acknowledgement to the MT-SMS message.

A46. The control node according to embodiment A43, wherein the control node is further operative to:

receive, via the sub-layer from the wireless communication device, a mobile originated SMS (MO-SMS) message

A47. The control node according to embodiment A46, wherein the control node is further operative to:

transmit, via the sub-layer from the wireless communication device in response to receiving the MO-SMS message, an acknowledgement to the MO-SMS message.

A48. The control node according to embodiment A43, wherein the SMS protocol stack further includes a Short Message Application Layer (SM-AL) and a Short Message Transport Layer (SM-TL) that are higher in the protocol stack with respect to the layer for relaying SMS messages, wherein the layer for relaying SMS messages provides at least one service primitive required by the SM-TL.

A49. The control node according to embodiment A43, wherein the sub-layer is a layer used to convey small data for Cellular Internet-of-Things (CIot) devices.

A50. The control node according to embodiment A43, wherein the sub-layer is an Evolved Packet System Mobility Management (EMM) sub-layer.

A51. The control node according to embodiment A50, wherein the control node selects the sub-layer being one of a layer used to convey small data for Cellular Internet-of-Things devices and an Evolved Packet System Mobility Management (EMM) sub-layer.

A52. The control node according to embodiment A43, wherein the control node selects the sub-layer being one of a layer used to convey small data for Cellular Internet-of-Things devices and an Evolved Packet System Mobility Management (EMM) sub-layer.

A53. The control node according to embodiment A43, wherein a header is used to distinguish SMS messages from other small data sent over the sub-layer used to convey small data for Cellular Internet-of-Things (CIoT) devices; and

wherein the header for a mobile originated (MO) SMS is added in the wireless communication device and removed by the control node, and

wherein the header for a mobile terminated (MT) SMS is added by the control node and removed by the wireless communication device.

A54. The control node according to embodiment A43, wherein the wireless communication device is a mobile terminal.

A55. The control node according to embodiment A43, wherein the wireless communication device is a Cellular Internet of Things (CIoT) device.

A56. The control node according to embodiment A43, wherein the control node is a Mobility Management Entity (MME) node.

A57. The control node according to embodiment A43, wherein the control node is a Cellular Internet of Things Serving Gateway Node (C-SGN).

Although terminology from 3GPP has been used in this disclosure to exemplify the exemplary embodiments, one of ordinary skill in the art would understand this as not limiting the scope of the present embodiments to only the aforementioned system. Other wireless systems, including LTE, LTE-A, WiMax, UMB and GSM, may also benefit from exploiting the ideas covered within this disclosure.

Furthermore, the terminology such as NodeB and UE are non-limiting and does in particular do not imply a certain hierarchical relation between the two; in general “NodeB” could be considered as device 1 and “UE” device 2, and these two devices communicate with each other over some radio channel.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that, although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or non-transitory computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the following examples of embodiments and their equivalents, and shall not be restricted or limited by the foregoing detailed description.

### ABBREVIATIONS

DL Downlink

UP Uplink

MO Mobile Originated

MT Mobile Terminated

MBB Mobile Broad Band

CIoT Cellular Internet of Things

C-SGN CIoT Serving Gateway Node

RAT Radio Access Technology (e.g. LTE, 3G, 2G or Narrow

Band CIoT RAT)

NB Narrow Band (here: new radio protocols for CIoT)

MME Mobility Management Entity

C-SGN Cellular Serving Gateway Node

1. A method performed in a wireless communication device, the method comprising:
the wireless communication device implementing a Short Message Service (SMS) protocol stack that includes a layer for relaying SMS messages that is configured to provide a communication interface between the wireless communication device and a control node; and
the layer for relaying SMS messages using a sub-layer configured to deliver small data between the wireless communication device and the control node.

2. The method according to claim 1, further comprising:
receiving, via the sub-layer from the control node, a mobile terminated SMS (MT-SMS) message.

3. The method according to claim 2, further comprising:
transmitting, via the sub-layer to the control node in response to receiving the MT-SMS message, an acknowledgement to the MT-SMS message.

4. The method according to claim 1, further comprising:
transmitting, via the sub-layer to the control node, a mobile originated SMS (MO-SMS) message

5. The method according to claim 4, further comprising:
receiving, via the sub-layer from the control node in response to transmitting the MO-SMS message, an acknowledgement to the MO-SMS message.

6. The method according to claim 1, wherein the SMS protocol stack further includes a Short Message Application Layer (SM-AL) and a Short Message Transport Layer (SM-TL) that are higher in the protocol stack with respect to the layer for relaying SMS messages, wherein the layer for relaying SMS messages provides at least one service primitive required by the SM-TL.

7. The method according to claim 1, wherein the sub-layer is a layer used to convey small data for Cellular Internet-of-Things devices.

8. The method according to claim 1, wherein the sub-layer is an Evolved Packet System Mobility Management (EMM) sub-layer.

9. The method according to claim 1, wherein the WCD selects the sub-layer being one of a layer used to convey small data for Cellular Internet-of-Things devices and an Evolved Packet System Mobility Management (EMM) sub-layer.

10. The method according to claim 1, wherein a header is used to distinguish SMS messages from other small data sent over the sub-layer used to convey small data for Cellular Internet-of-Things (CIoT) devices, and
wherein the header for a mobile originated (MO) SMS is added in the wireless communication device and removed by the control node, and
wherein the header for a mobile terminated (MT) SMS is added by the control node and removed by the wireless communication device.

11. The method according to claim 1, wherein the wireless communication device is a mobile terminal.

12. The method according to claim 1, wherein the wireless communication device is a Cellular Internet of Things (CIoT) device.

13. The method according to claim 1, wherein the control node is a Mobility Management Entity (MME) node.

14. The method according to claim 1, wherein the control node is a Cellular Internet of Things Serving Gateway Node (C-SGN).

15. A method performed in a control node, the method comprising:
the control node implementing a Short Message Service (SMS) protocol stack that includes a layer for relaying SMS messages that is configured to provide a communication interface between the control node and a wireless communication device; and
the layer for relaying SMS messages using a sub-layer which is configured to deliver small data between the control node and the wireless communication device.

16. The method according to claim 15, further comprising:
transmitting, via the sub-layer to the wireless communication device, a mobile terminated SMS (MT-SMS) message

17. The method according to claim 16, further comprising:
receiving, via the sub-layer from the wireless communication device in response to transmitting the MT-SMS message, an acknowledgement to the MT-SMS message.

18. The method according to claim 15, further comprising:
receiving, via the sub-layer from the wireless communication device, a mobile originated SMS (MO-SMS) message

19. The method according to claim 18, further comprising:
transmitting, via the sub-layer from the wireless communication device in response to receiving the MO-SMS message, an acknowledgement to the MO-SMS message.

20. The method according to claim 15, wherein the SMS protocol stack further includes a Short Message Application Layer (SM-AL) and a Short Message Transport Layer (SM-TL) that are higher in the protocol stack with respect to the layer for relaying SMS messages, wherein the layer for relaying SMS messages provides at least one service primitive required by the SM-TL.

21. The method according to claim 15, wherein the sub-layer is a layer used to convey small data for Cellular Internet-of-Things (CIot) devices.

22. The method according to claim 15, wherein the sub-layer is an Evolved Packet System Mobility Management (EMM) sub-layer.

23. The method according to claim 15, wherein the control node selects the sub-layer being one of a layer used to convey small data for Cellular Internet-of-Things devices and an Evolved Packet System Mobility Management (EMM) sub-layer.

24. The method according to claim 15, wherein a header is used to distinguish SMS messages from other small data sent over the sub-layer used to convey small data for Cellular Internet-of-Things (CIoT) devices; and
wherein the header for a mobile originated (MO) SMS is added in the wireless communication device and removed by the control node, and
wherein the header for a mobile terminated (MT) SMS is added by the control node and removed by the wireless communication device.

25. The method according to claim 15, wherein the wireless communication device is a mobile terminal.

26. The method according to claim 15, wherein the wireless communication device is a Cellular Internet of Things (CIoT) device.

27. The method according to claim 15, wherein the control node is a Mobility Management Entity (MME) node.

28. The method according to claim 15, wherein the control node is a Cellular Internet of Things Serving Gateway Node (C-SGN).

29. A wireless communication device (WCD) comprising:
a processor;
a computer readable medium coupled to the processor, said computer readable medium containing instructions executable by the processor, whereby the WCD is operative to:
implement a Short Message Service (SMS) protocol stack that includes a layer for relaying SMS messages that is configured to provide a communication interface between the wireless communication device and a control node, and
the layer for relaying SMS messages using a sub-layer configured to deliver small data between the wireless communication device and the control node.

30. A control node comprising:
a processor;
a computer readable medium coupled to the processor, said computer readable medium containing instructions executable by the processor, whereby the control node is operative to:
implement a Short Message Service (SMS) protocol stack that includes a layer for relaying SMS messages that is configured to provide a communication interface between the control node and a wireless communication device, and
the layer for relaying SMS messages using a sub-layer which is configured to deliver small data between the control node and the wireless communication device.
